(19) United States
(12) Patent Application Publication
(10) Pub. No.: US 2025/0382987 A1
(43) Pub. Date: Dec. 18, 2025

(54) Mechanical Lock Nut Retainment System

(71) Applicant: Digga Australia Pty Ltd, Yatala, Queensland (AU)

(72) Inventors: Stephen Gough, Yatala, Queensland (AU); Sean Zajac, Yatala, Queensland (AU)

(73) Assignee: Digga Australia Pty Ltd, Yatala, Queensland (AU)

(21) Appl. No.: 18/877,587

(22) PCT Filed: Jun. 23, 2023
(86) PCT No.: PCT/AU2023/050574

§ 371 Date: Dec. 20, 2024

(30) Foreign Application Priority Data
Jun. 23, 2022 (AU) 2022901731

(51) Int. Cl. F16B 39/24; F16B 39/282

(52) U.S. Cl. CPC F16B 39/24; F16B 39/282

(57) ABSTRACT

A mechanical lock nut retainment system enables accurate retention of a specified assembled position and torque of a lock nut. The system includes: a shaft having external threads on a threaded portion and external splines on a splined portion; a lock nut having internal threads that are threaded onto the threaded portion of the shaft, and the nut having spaced grooves extending around a circumference of the nut; and a lock washer having internal splines receivable on the splines of the splined portion of the shaft, and the washer having spaced teeth extending around a circumference of the washer. The spaced teeth of the washer are receivable in the spaced grooves of the nut.

### FIELD OF THE INVENTION

The present invention relates generally to lock nut retainment systems and, in particular but not exclusively, to mechanical lock nut retainment systems for machinery bearings.

### BACKGROUND

Heavy-duty equipment in the fields of, for example, mining, construction, earth moving and agriculture is often exposed to extremely harsh conditions, where severe vibrations and impacts demand highly robust components. Thus, engineers of such equipment are faced with difficult challenges when designing systems and parts that can maintain design specifications and tolerances, which are often essential for efficient operation and durability over prolonged periods of harsh use.

For example, mechanical bearings such as roller bearings are commonly fitted to machinery systems such as power take-offs (PTOs), axles and gears according to strict specifications. If a bearing is attached too tightly both the bearing and dependent components may wear prematurely; and if a bearing is attached too loosely it can introduce excessive tolerances that may lead to excessive wear or catastrophic mechanical failure.

Therefore, lock nuts have been used for generations to retain bearings at specified assembled pre-loads. Such assembled pre-loads are generally translated to a specified torque value of a given lock nut. A locking mechanism is then commonly used to retain the lock nut in position after the specified torque value is achieved.

Numerous designs of nut locking mechanisms have been devised, which designs generally focus on an application's requirements concerning particular factors such as robustness or strength, or ease of assembly, removal, or adjustment. Locking mechanisms thus include cotter keys, split pins and various types of lock washers, such as spring washers and internal or external toothed washers, Lock nuts and retainment systems fall into two general categories, mechanical/physical retainment or friction/chemical assisted retainment.

However, existing nut locking mechanisms generally fail to provide the level of precision, robustness and security demanded of heavy-duty equipment, while simultaneously providing an ease of assembly and disassembly. Further, similar difficulties can be associated with nut locking systems concerning much smaller scale equipment, even including micromachinery.

There is therefore a need for an improved mechanical lock nut retainment system.

### OBJECT OF THE INVENTION

It is an object of the present invention to overcome and/or alleviate one or more of the disadvantages of the prior art or provide the consumer with a useful or commercial choice.

### SUMMARY OF THE INVENTION

In a first aspect, although it need not be the only or the broadest aspect, the invention resides a mechanical lock nut retainment system, comprising:
a shaft having external threads on a threaded portion and external splines on a splined portion;
a lock nut having internal threads that are threaded onto the threaded portion of the shaft, and the nut having spaced grooves extending around a circumference of the nut; and
a lock washer having internal splines receivable on the splines of the splined portion of the shaft, and the washer having spaced teeth extending around a circumference of the washer;
wherein the spaced teeth of the washer are receivable in the spaced grooves of the nut.

Preferably, an angle θ between the spaced teeth is not evenly divisible by an angle β between the splines, and also the angle β is not evenly divisible by the angle θ.

Preferably, the spaced grooves of the nut extend inward along an end face of the nut and parallel to a longitudinal axis of the shaft.

Preferably, the spaced teeth of the washer are separated by radial slots extending longitudinally from an outer end face to an inner end face of the washer.

Preferably, at least one of the radial slots is longer than another, so that the spaced teeth of the washer are not evenly spaced apart radially around a circumference of the washer.

Preferably, the spaced grooves of the nut are evenly spaced apart radially around a circumference of the nut.

Preferably, the system further comprises a bearing positioned on the shaft.

Preferably, the system further comprises an output housing, wherein the bearing is compressed longitudinally between the lock nut and the output housing.

Preferably, the system further comprises a transmission gearset that receives a distal end of the shaft.

Preferably, the transmission gearset comprises a sun gear and a plurality of planetary gears.

Preferably, the spline is a DIN 5482 spline, an SAE spline, or an alternative spline defined by flats and corners of a triangular-, square-, pentagon-, hexagon-, heptagon-, octagon-, etc, shaped shaft portion cross section.

Preferably, the internal threads of the nut are M70 threads or any other form of thread.

Preferably, the system further comprises a motor or engine connected to the transmission gearset.

Preferably, the spaced grooves of the nut define internal splines and extend inward along an internal circumference of the nut and perpendicular to a longitudinal axis of the shaft.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 is an exploded perspective view of a lock nut and a lock washer, according to an embodiment of the present invention.

FIG. 2 is a side view of the lock washer of FIG. 1.

FIG. 3 is a side view of the lock nut of FIG. 1.

FIG. 4 is an end view of the lock nut of FIG. 1, showing an angle θ between each of the spaced grooves.

FIG. 5 is an end view of the lock washer of FIG. 1, showing an angle θ between some of the spaced teeth and an angle β between the splines of the shaft.

FIG. 6 is an exploded perspective view of a rotary power transmission system, which includes a lock nut retainment system having the lock nut and lock washer of FIG. 1, according to an embodiment of the present invention.

FIG. 7 is an assembled side view of the rotary power transmission system of FIG. 6.

FIG. 8 is an end view of a lock nut, according to an alternative embodiment of the present invention.

FIG. 9 is an end view of a lock washer that fits into and locks the lock nut of FIG. 8 to a shaft, according to an alternative embodiment of the present invention.

### DETAILED DESCRIPTION

The present invention relates to a lock nut retainment system. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, inside and outside, above and below, longitudinally and transverse, top and bottom, upper and lower, rear, front and side, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the present invention is defined as a mechanical lock nut retainment system, comprising:
a shaft having external threads on a threaded portion and external splines on a splined portion;
a lock nut having internal threads that are threaded onto the threaded portion of the shaft, and the nut having spaced grooves extending around a circumference of the nut; and
a lock washer having internal splines receivable on the splines of the splined portion of the shaft, and the washer having spaced teeth extending around a circumference of the washer;
wherein the spaced teeth of the washer are receivable in the spaced grooves of the nut.

Advantages of embodiments of the present invention include a robust system that accurately retains a specified assembled position and torque of a lock nut. Further, embodiments of the present invention enable the lock washer to be easily and quickly installed or removed, and without the need for specialty tools.

Also, embodiments of the present invention enable a lock nut retainment system that is resistant to inadvertent loosening as a result of vibration and/or impact forces.

Those skilled in the art will appreciate that not all of the above advantages are necessarily present in all embodiments of the present invention.

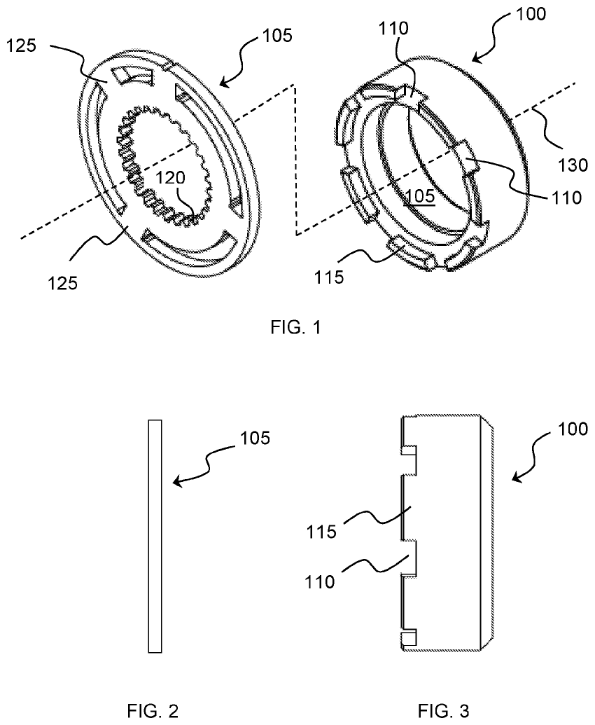

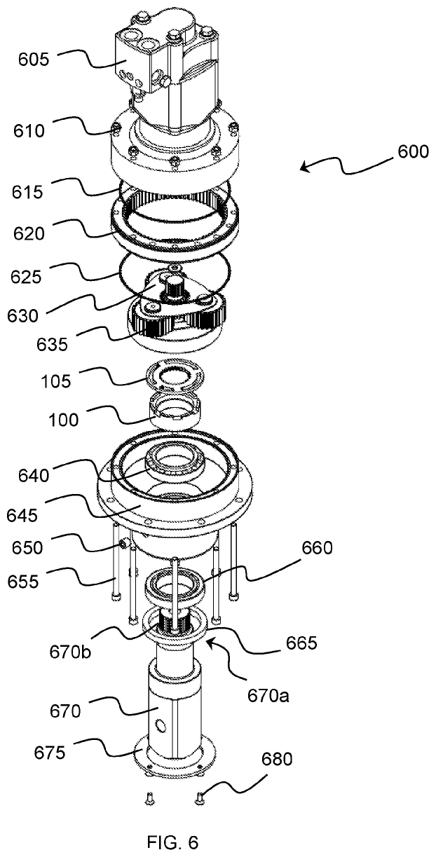

FIG. 1 is an exploded perspective view of a lock nut 100 and a lock washer 105, according to an embodiment of the present invention. The nut 100 includes internal threads cut into an internal face 105, where in use the internal threads are threaded onto a threaded portion of a shaft, such as the motor-powered output shaft 670 as shown in FIG. 6. Further, the nut 100 includes spaced grooves 110 extending around a circumference of the nut 100, where the spaced grooves 110 define protruding portions 115 between the spaced grooves 110.

The lock washer 105 includes internal splines 120 receivable on splines of a splined portion of the shaft, such as the splined portion 670b of the shaft 670 shown in FIG. 6. The washer 105 further includes spaced teeth 125 extending around a circumference of the washer 105.

During assembly of an associated system, after the lock nut 100 is torqued to the correct value, the lock washer 105 is slid along a longitudinal axis 130 of the shaft, such that the spaced teeth 125 are received in the spaced grooves 110 of the lock nut 100, and thereby mechanically prevents further rotation of the lock nut 100 about the shaft.

FIG. 2 is a side view of the lock washer 105.

FIG. 3 is a side view of the lock nut 100.

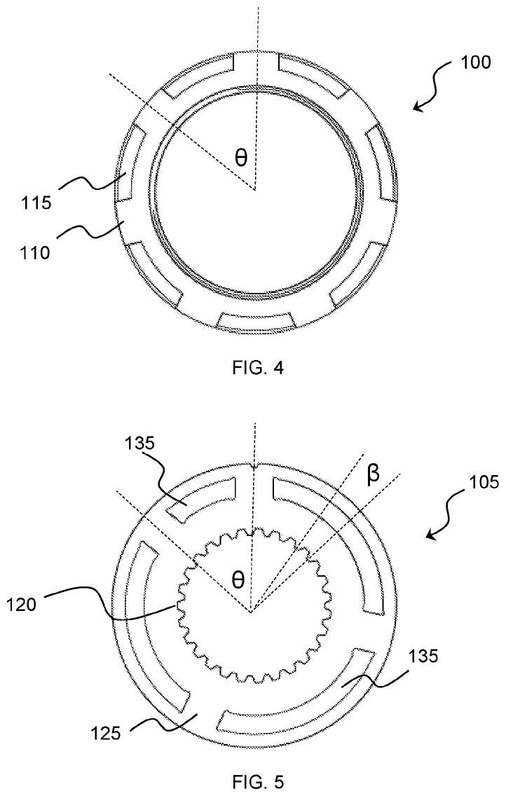

FIG. 4 is an end view of the lock nut 100, showing an angle θ between each of the spaced grooves 110.

FIG. 5 is an end view of the lock washer 105, showing the same angle θ of FIG. 4 but between some of the spaced teeth 125. Other spaced teeth 125 are separated by a multiple of the angle θ, such as two times angle θ. The spaced teeth 125 also define distal ends of radial slots 135 cut through the lock washer 105, where as shown one of the slots 135 is shorter than the others.

The radial slots 135 can be of any length, and can enable a custom tool to be made and that fits into the slots 135 for increasing or decreasing the torque on the lock nut 100.

According to some embodiments, the angle θ between the spaced teeth 125 is not evenly divisible by an angle β between the internal splines 120 of the lock washer 105, and also the angle β is not evenly divisible by the angle θ. That enables, when the lock nut 100 is threaded onto a shaft, each of the spaced grooves 110 to define a unique rotational relationship between the lock nut 100 and the lock washer 105. For example, consider that the lock nut 100 as shown includes seven (7) spaced grooves 110. That enables the lock washer 105 to be rotationally positioned relative to the lock nut 100, about the longitudinal axis 130, in gradations of angle β divided by seven (7).

Thus, depending on the tolerances between the spaced teeth 125 and the spaced grooves 110, when the spaced teeth 125 are received in the spaced grooves 110, the lock washer 105 is able to very precisely fix the lock nut 100 in a specific rotational (and thus longitudinal) position on the shaft. That can be useful in applications that require the lock nut 100 to be tightened to a torque specification that corresponds to a specific axial loading, and where subsequent tightening or loosening of the nut 100 is prohibited by the lock washer 105. One example of such an application includes the rotational mounting of a machinery implement on a shaft using roller bearings, as illustrated in FIG. 6.

FIG. 6 is an exploded perspective view of a rotary power transmission system 600, which includes a lock nut retainment system having the above described lock nut 100 and lock washer 105, according to an embodiment of the present invention, and where a vertical line (not shown) through the middle of the figure defines the longitudinal axis 130. For example, the system 600 can be part of a heavy-duty power take-off (PTO) device of mining, construction, earth moving or agriculture machinery.

As shown from top to bottom, the system 600 includes a motor 605, retaining nuts 610, an O-ring 615, a ring gear 620, an O-ring 625, a gear set 630 including planetary gears 635, the lock washer 105, the lock nut 100, a first roller bearing 640, an output housing 645, a pressure plug 650, retaining bolts 655, a second roller bearing 660, a seal 665, an output shaft 670 including a threaded portion 670a and a splined portion 670b, a seal protector 675, and screws 680.

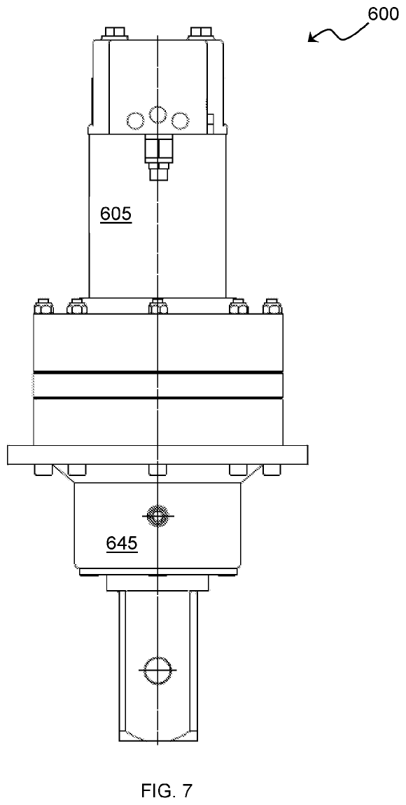

FIG. 7 is an assembled side view of the rotary power transmission system 600.

During assembly of the rotary power transmission system 600, the lock nut 100 is tightened onto the threaded portion 670a of the output shaft to a given torque specification, which will ensure optimal running life and efficiency of the first and second roller bearings 640, 660. The lock washer 105 is then positioned on the splined portion 670b of the output shaft 670 so that the spaced teeth 125 fit into the spaced grooves 110 as described previously. If during a first attempt the spaced teeth 125 and spaced grooves 110 do not quite align, the lock washer 105 is simply slipped off the shaft 670, rotated by one spacing (approximately the angle θ as shown in FIG. 5), and then slipped back onto the shaft 670. That process is continued until the spaced teeth 125 fit effectively into the spaced grooves 110. After the system 600 is fully assembled and the retaining bolts 655 are fastened, the gear set 630 prevents the lock washer 105 from moving longitudinally along the shaft 670 and off of the splined portion 670b, such that the lock nut 100 is robustly fixed in position on the output shaft 670. The bearings 640, 660 should then remain at or near their specified longitudinal loading throughout their operational life or until a disassembly or service of the rotary power transmission system 600.

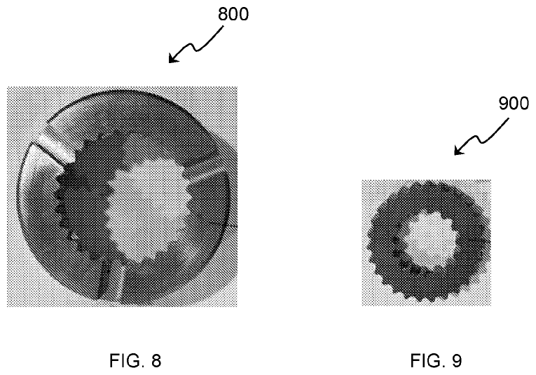

Those skilled in the art will appreciate that other embodiments of the present invention may adopt quite different shapes, while retaining the functionality and advantages of the present invention. For example, FIG. 8 illustrates an alternative form of a lock nut 800, which includes internal threads (not shown) on one end and internal teeth on the other end. FIG. 9 illustrates an alternative form of a lock washer 900, which includes external teeth that mesh with the internal teeth of the lock nut 800. Internal splines of the lock washer 900 then match the splines of a corresponding shaft (not shown) with a threaded portion and a splined portion, similar to the shaft 670 as described above. The lock washer 900 is thus able to fix the position of the lock nut 800 on the shaft, similar to the operation of the lock washer 105 and lock nut 100 as described above.

Those skilled in the art also will appreciate that the lock nut retainment system of the present invention is entirely scalable from, for example, large and heavy-duty mining machinery to extremely small micromachinery and micro electromechanical systems (MEMS). Accordingly, components of the present invention can be manufactured from a wide range of materials including steel and other alloys, various polymers and ceramics.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A mechanical lock nut retainment system, comprising:
a shaft having external threads on a threaded portion and external splines on a splined portion;
a lock nut having internal threads that are threaded onto the threaded portion of the shaft, and the nut having spaced grooves extending around a circumference of the nut; and
a lock washer having internal splines receivable on the splines of the splined portion of the shaft, and the washer having spaced teeth extending around a circumference of the washer;
wherein the spaced teeth of the washer are receivable in the spaced grooves of the nut-;
wherein the spaced teeth of the washer are separated by radial slots extending longitudinally from an outer end face to an inner end face of the washer; and
wherein at least one of the radial slots is longer than another, so that the spaced teeth of the washer are not evenly spaced apart radially around a circumference of the washer.

2. The mechanical lock nut retainment system of claim 1, wherein an angle θ between the spaced teeth is not evenly divisible by an angle β between the splines, and also the angle β is not evenly divisible by the angle θ.

3. The mechanical lock nut retainment system of claim 1, wherein the spaced grooves of the nut extend inward along an end face of the nut and parallel to a longitudinal axis of the shaft.

4. (canceled)

5. (canceled)

6. The mechanical lock nut retainment system of claim 1, wherein the spaced grooves of the nut are evenly spaced apart radially around a circumference of the nut.

7. The mechanical lock nut retainment system of claim 1, further comprising a bearing positioned on the shaft.

8. The mechanical lock nut retainment system of claim 7, further comprising an output housing, wherein the bearing is compressed longitudinally between the lock nut and the output housing.

9. The mechanical lock nut retainment system of claim 1, further comprising a transmission gearset that receives a distal end of the shaft.

10. The mechanical lock nut retainment system of claim 9, wherein the transmission gearset comprises a sun gear and a plurality of planetary gears.

11. The mechanical lock nut retainment system of claim 1, wherein the spline is a DIN 5482 spline, an SAE spline, or an alternative spline defined by flats and corners of a triangular-, square-, pentagon-, hexagon-, heptagon-, octagon-, etc, shaped shaft portion cross section.

12. The mechanical lock nut retainment system of claim 1, wherein the internal threads of the nut are M70 threads.

13. The mechanical lock nut retainment system of claim 9, further comprising a motor or engine connected to the transmission gearset.

14. The mechanical lock nut retainment system of claim 1, wherein the spaced grooves of the nut define internal splines and extend inward along an internal circumference of the nut and perpendicular to a longitudinal axis of the shaft.
